(19) United States
(12) Patent Application Publication
(10) Pub. No.: US 2004/0252322 A1
(43) Pub. Date: Dec. 16, 2004

(54) Job management apparatus

(75) Inventors: Kazuhito Gassho, Nagano-ken (JP); Noriyuki Nagai, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/716,874

(22) Filed: Nov. 20, 2003

(30) Foreign Application Priority Data
Nov. 21, 2002 (JP) 2002-337455(P)

(51) Int. Cl. G06F 15/00

(52) U.S. Cl. 358/1.14; 358/1.16

(57) ABSTRACT

The technique of the present invention enhances convenience in managing print jobs on a print server.

A printing system includes an external print server 100, a printer 200 and clients PC1-PC4 that are connected together via a network. The print server 100 retains the print job after transmitting it to the printer 200 and synchronizes print job status of the print server 100 with that of the printer 200 in response to notification from the printer 200. When any error occurs in printing process, the print server 100 transfers the status of the print job corresponding to the error to “held”. This application enables the user to utilize the print job retained in the print server 100 effectively to restart the print job without requirement of re-submission after examining the cause of the error.

### BACKGROUND OF THE INVENTION

1. Field of the Invention

The present invention relates to a job management apparatus connected with a network separately from a printing device that manages status of a print job.

2. Description of the Related Art

With recent advance of LAN (Local Area Network), it became popular to share one or more printers connected with a network among plural computers (hereinafter referred to as “client computers”) that are also connected to the network. Each of client computers transmits a plurality of print jobs to the printer. In order to control the above printing processing, a print server is incorporated in the printer or is provided separately.

Each print job is printed out through various statuses defined in International Standard ISO/IEC10175-1 (hereinafter simply referred to as “international standard”).

FIG. 1 schematically illustrates a general outline of statuses defined in the international standard. Once the print job has been received, the print job status is changed from “receiving” to “pending” (arrow tr1). The print job status in “pending” is changed to “interPreting” at a print timing (arrow tr2). The print job in “interPreting” is subjected to interpretation, and then the status is changed to “printWaiting” upon the completion of the interpretation (arrow tr3). When printing is ready, the print job status in “printWafting” is changed to “printing” (arrow tr4). The print job status is changed to “completed” upon the completion of the printing of the print job in “printing” status (arrow tr5). In some cases, it is instructed to retain the print job for a certain period after the printing processing has been completed. The status of such print job is changed to “retained” after “completed” (arrow tr7). The print job in “retained” status is not deleted but retained until either one of conditions, input of re-printing instruction by the user and elapse of predetermined period, is fulfilled. When the user instructs re-printing of the print job in “retained” status through the interface of the client computer or the printer, the status is changed to “pending” again (arrow tr9).

In addition to the above-mentioned processing, most of the print servers function to withhold the print job in “held” status. In one application, the change to “held” is performed in response to the user instruction through the interface of the client computer or the printer, and may be performed from “pending”, “interPreting”, “printWaiting”, “printing” and “completed” (arrow tr6). In another application, instruction data of the change to “held” attached to the print job can change the status to “held”. The print job in “held” status is retained until the user instruction is submitted. The print job status is changed back to “pending” in response to the user instruction for cancel (arrow tr8). Also, the print job in “held” status may be deleted by the user instruction.

Respective print jobs are temporarily stored in a spooling buffer in the print server, and are transferred to the printer for printing one by one. Typically, the print job in the print server is deleted after the transmission.

In some cases, it is, however, inconvenient to employ the above print job management system in performing the practical printing. For example, during printing process between the transmission of the print job to the printer and normal completion, there may occur a printer error, such as out of paper, ink and memory, or print job error. Because the print job with such error may cause unrecoverable failure, such as garble, the user is required to reissue the print job.

### SUMMARY OF THE INVENTION

The object of the present invention is thus to solve those problems and provide a technique that enhances convenience in printing on a print system employing a print server.

To solve at least part of the above problems, the present invention is directed to the print system where a job management apparatus is separated from a printing device and is connected with a printing device via a network. The job management apparatus, such as a print server, manages the status of a print job. The job management apparatus of the present invention comprises: a retention module that stores the print job, a transmitter that transmits each of the stored print jobs and a delete inhibition module that inhibits the retention module from deleting the print job which has been transmitted out.

The job management apparatus of the present invention, which is provided separately from the printing device, ensures normal performance of the job management apparatus even if any error occurs in the printing device. The job management apparatus even remains the print job which has been transmitted out, instead of deleting it. This application thus removes requirement for submitting the print job again by the user to restart the print job even if any error occurs on the printing device.

In accordance with the present invention, it is preferable to inhibit the delete of all print jobs which have been transmitted to the printing device. It is, however, not restricted but only part of the print jobs more than certain size may be inhibited from being deleted. Because submitting smaller-size print job is not a heavy task, loss of convenience is little even if is it deleted. Thus, the above limitation achieves saving of memory size of the job management apparatus as well as ensuring of convenience.

Delete inhibition can be achieved in various manners where the transmitted print jobs are substantially retained in the job management apparatus. In one available example, a status indicating “transmission completed” is provided for a print job which has been transmitted to the printing device so as to prevent the print job in the status from being deleted. The job management apparatus may have limited function of deleting the print jobs according to quite restrictive condition, such as the user instruction. In this case, the limited function of deleting the print job substantially works as delete-inhibition function.

In accordance with the present invention, the delete inhibition module may allow the retention module to delete the print job in response to receipt of completion notification of the corresponding print job from the printing device. Because it is less useful to retain the print job in successful completion, deleting it at the above timing can save memory size of the job management apparatus. The timing of deleting the print job is not limited to upon and immediately after the receipt of the completion notification, but the print job may be retained for predetermined period after printed out.

In accordance with the present invention, when receiving notification of the print job status in the printing device, the retention module preferably changes the status of the corresponding print job to the notified status. This application ensures synchronization of the print job status between the job management apparatus and the printing device.

In accordance with the present invention, in response to detection of print error in the printing device, the retention module preferably functions to change the status of the corresponding print job to halt status. The halt status, such as “held” in the international standard, means storing the print job out of print queue. This application enables the user to instruct the printing by re-using the print job stored in the job management apparatus after examination of cause of the error and so on. To facilitate restart of the printing, the job management apparatus may preferably change the print job status in halt status to printable status in response to the printing instruction by the user. The failed print job is preferably to be deleted in response to judgment on the printing device or instruction from the job management apparatus.

A diversity of embodiments may be applicable for detecting errors. In one applicable embodiment, errors can be detected based on error notification from the printing device. In another applicable embodiment, the job management apparatus may inquire to the printing device regarding at least either one of the status of the printing device or that of the print job. This inquiry may be performed under predetermined condition, for example, where the printing device has not sent any status notification for over predetermined period of time. In yet another applicable embodiment, the job management apparatus may determine that error has occurred in the printing device in the case where the printing device has not sent notification regarding performance status of the print job, such as response to the status inquiry, over predetermined period of time.

The present invention may also be directed to a printing device which is used together with the above job management apparatus. The printing device of the present invention includes a job management module that manages a print job by associating it with one of plural statuses that are preset, and a notification module that informs the job management apparatus of the status every time the print job status is changed. This arrangement enables the job management apparatus to manage the status of the transmitted print job with comparative ease. The error notification and the completion notification are also included in the status notification.

The technique of the present invention is not restricted to the applications of the job management apparatus described above, but may be actualized by a diversity of other applications, such as a print job management method, a computer program attaining such a method and a recording medium in which such a computer program is recorded. Such recording medium may include a variety of computer-readable media such as flexible disk, CD-ROM, magneto-optics disc, IC card, ROM cartridge, punched card, print with barcodes or other codes printed thereon, internal storage device (memory such as RAM and ROM) and external storage device of the computer and the like.

### BRIEF DESCRIPTION OF THE DRAWING

FIG. 1 schematically illustrates a general outline of statuses defined in the international standard.

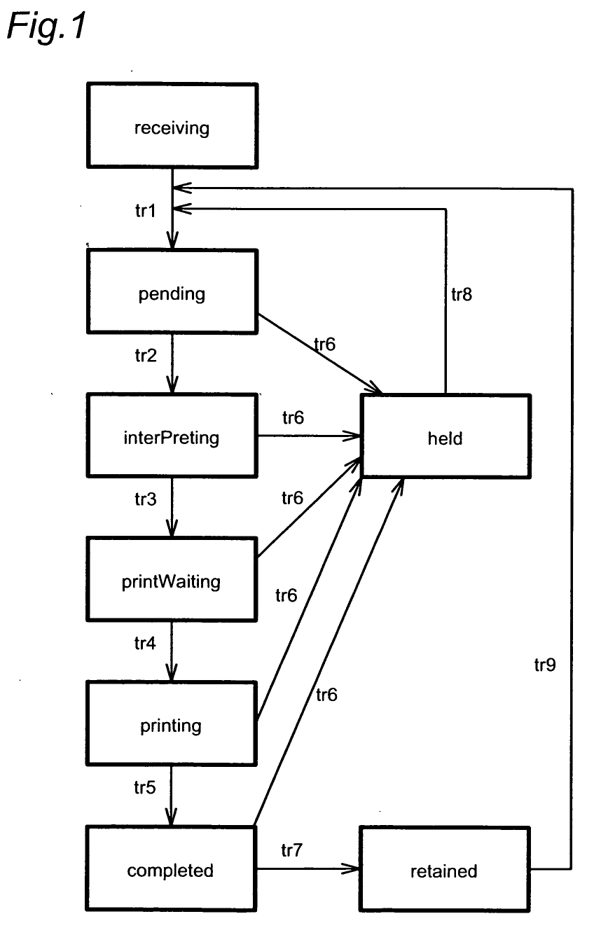

FIG. 2 illustrates the structure of a printing system in accordance with an embodiment.

FIG. 3 is a flow chart illustrating printing processing.

FIG. 4 is a flow chart illustrating error detection processing.

### DESCRIPTION OF THE PREFERRED EMBODIMENTS

Some modes of carrying out the invention are discussed below as embodiments in the following order.

A. Structure of System

B. Printing Processing

C. Error Detection Processing

D. Modifications

A. Structure of System

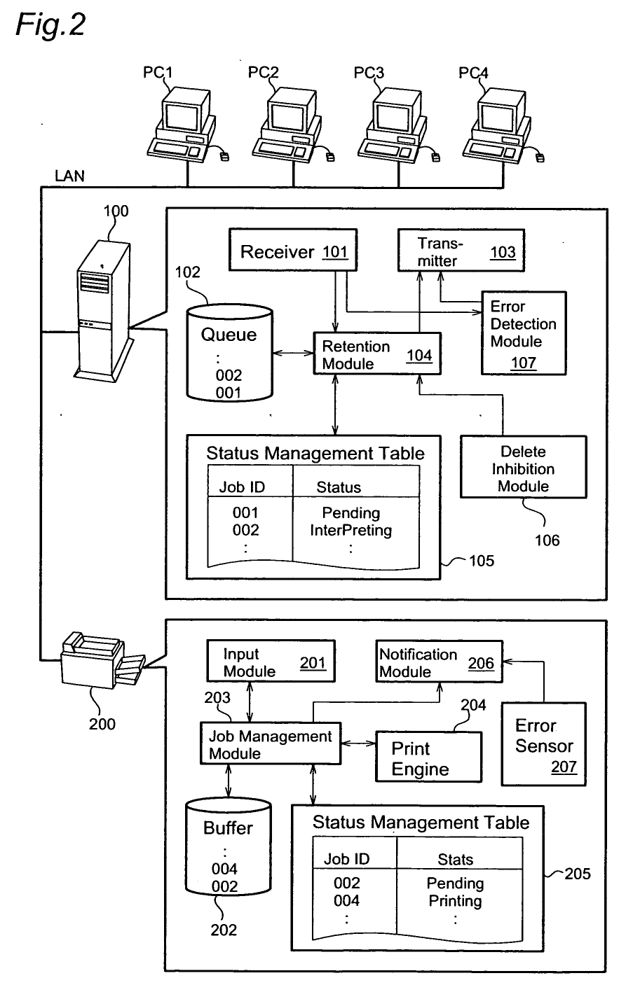

FIG. 2 illustrates the structure of a printing system in accordance with an embodiment. Client computers PC1-PC4, a print server 100 and a printer 200 are connected together via LAN (Local Area Network). The print server 100 is configured separately from the printer 200 and functions as a job management apparatus that manages statuses of print jobs. The number of the client computers and the printers are not limited as mentioned above.

Respective client computers PC1-PC4 are general purpose computers that function to create documents and images using various application programs. The print jobs including such document or image data are transmitted from client computers PC1-PC4 to the print server 100 to be printed out. The print job is packetized according to specific communication protocol and then transmitted to the print server 100 via LAN. The print server 100 includes a spooling queue 102 that temporarily stores the received print jobs. The print server 100 manages the statuses of a number of print jobs received from the client computers PC1-PC4 and performs printing sequentially.

FIG. 2 illustrates functional blocks attaining functions as a job management apparatus in the print server 100. The respective functional blocks, except for the queue 102, are actualized by software with an installation of a computer program for job management on the print server 100.

A receiver 101 receives the print jobs from the client computers PC1-PC4 via the network. The received print jobs are stored in the queue 102. The receiver 101 also functions to receive various notifications from the printer 200. These notifications include completion notification of the print job, status notification of the print job and error notification in the printer 200. A transmitter 103 transmits the print job spooled in the queue 102 to the printer 200 via the network. An error detector 107 detects errors of the print job that has been transmitted to the printer 200, based on information obtained from the receiver 101.

A retention module 104 stores/deletes the print job in/from the queue 102, changes the print job status and sends the print job out from the queue 102. A status management table 105, which is referred by the retention module 104, stores job ID attached to each print job and the corresponding status therein. In this embodiment, status management is performed according to the international standard.

In accordance with this embodiment, the print job is retained in the queue 102 after transmitted to the printer 200. The retention module 104 changes the status of the transmitted print job recorded in the status management table 105 based on the status notification or the error detection from the printer 200. If any error is detected, the print job status is changed to “held”. The print job status in “held” is changed to “pending” in response to the instruction input through the interface of the client computers PC1-PC4 or the printer 200.

A delete inhibition module 106 controls delete of the print jobs which have been transmitted to the printer 200. In other words, the delete inhibition module 104 inhibits the retention module 104 from deleting the print job which has been transmitted to the printer 200 as a rule. The delete inhibition module 106 then allows the retention module 104 to delete the corresponding print job when receiving the completion notification of the print job from the printer 200.

Functional blocks of the printer 200 are also shown in FIG. 2. The printer 200 incorporates a control unit comprising a microcomputer including a CPU, a ROM and a RAM. The respective functional blocks in FIG. 2, except for a buffer 202, are actualized by software in this control unit.

An input module 201 receives the print job from the print server 100. The received print job is temporarily stored in the spooling buffer 202. A job management module 203 stores/deletes the print job in/from the buffer 202, sends the print job from the buffer 202 to a print engine 204 and manages the print job status. Each of print job statuses is stored in a status management table 205 together with the corresponding job ID. The job management module 203 informs the print server 100 of the print job status through a notification module 206 every time the print job status is changed. An error sensor 207 detects an error occurred in the printer 200 and informs the print server 100 of the detected error through the notification module 206.

B. Printing Processing

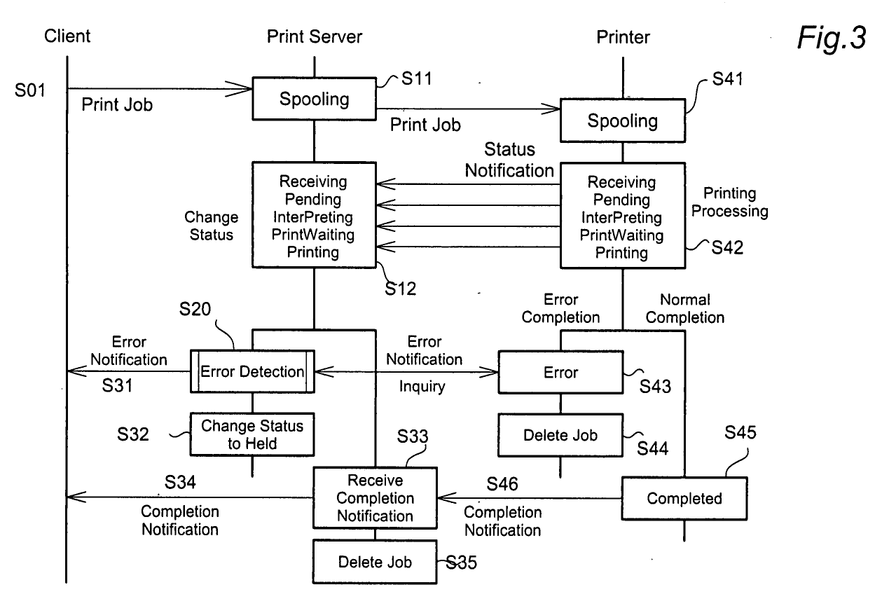

FIG. 3 is a flowchart of printing processing, which shows processing in the client computer on the left side, the processing in the print server 100 in the center and the processing in the printer 200 on the right side. The print server receives the print job from the client computers PC1-PC4 (Step S01). The print server 100 spools the received print job therein (Step S11), manages it by providing the status according to the international standard and transmits to the printer 200 subsequently. The print job transmitted from the print server 100 to the printer 200 is stored in the print server 100 even after being transmitted out.

The printer 200 receives the print job and spools it in the buffer temporarily (Step S41). Each print job is managed by providing various statuses according to the international standard, such as “pending”, in the buffer and printed out one by one (Step S42). The printer 200 informs the print server 100 of both the job ID and the status every time the status of each print job is changed. The print server 100 changes the corresponding print job status stored therein in response to the notification (Step S12).

In this embodiment, common names of statuses according to the international standard are provided regardless whether or not the print job has been transmitted to the printer 200. Whether or not the print job has been transmitted to the printer 200 may be confirmed based on whether or not the printer 200 stores the print job therein. The status management table 105 may include flag for each of print jobs, which indicates whether or not the print job has been transmitted to the printer 200. Different names may be applied between the statuses of the not-transmitted print job and those of the transmitted print job in order to judge easily as to whether or not the print job has been transmitted to the printer 200.

When any error regarding the printer or the print job occurs before the print job status becomes “completed” (Step S43), the printer 200, if it is communicable, sends the error notification to the print server 100 and deletes the print job in the printer (Step S44). When detecting the error based on the error notification from the printer or the inquiry to the printer (Step S20), the print server 100 informs the corresponding client computer of the detected error (Step S31) and changes the status of the failed print job in the print server to “held” (Step S32).

When the printing has been completed without any error and the print job status becomes “completed” (Step S45), the printer 200 sends the completion notification to the print server 100 (Step S46). Upon the receipt of the completion notification (Step S33), the print server 100 informs the corresponding client computer of completion of the print job (Step S34) and deletes the corresponding print job (Step S35). The print job may be deleted directly or may once be retained in “retained” status and then deleted after predetermined period of time has elapsed.

C. Error Detection Processing

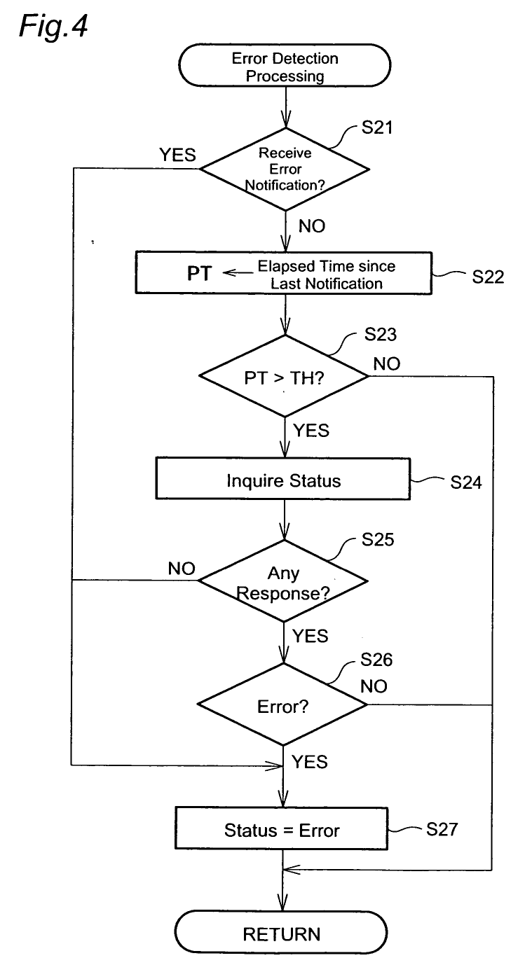

FIG. 4 is a flowchart of error detection processing that is performed by the error detection module 107 in the print server 100, which indicates processing in step S20 of FIG. 3 in detail.

When receiving the error notification from the printer 200 (Step S21), the error detection module 107 recognizes the error (Step S27). In case of receiving no error notification, the error detection module 107 specifies elapsed time since the last status notification was received from the printer 200 to be substituted to parameter PT (Step S22). When the elapsed time PT exceeds predetermined time TH (Step S23), the error detection module 107 transmits the job ID to the printer 200 to inquire the status (Step S24). If there is no response to the inquiry during the predetermined period of time (Step S25), it is judged that the printer 200 is in uncommunicable status, such as shut off and the print job has the error (Step S27). The “predetermined period of time” may be set on the basis of the time required for normal response. When there is a response within the predetermined period of time, the error detection module 107 judges whether or not the response indicates the error (Step S26). In case that the error, such as paper trouble or insufficient memory, is detected, it is judged as error (Step S27).

The print server 100 in the printing system of the present invention, which is provided separately from the printer 200, ensures normal performance of the print server 100 even if any error occurs on the printer 200. The print server 100 even remains the print job which has been transmitted out, instead of deleting it, thereby removing requirement for submitting the print job again by the user to restart the print job even if any error occurs on the printer 200.

D. Modifications

In the above embodiment, the error is detected using three applications together (See FIG. 4), the error notification from the printer 200 (Step S21), the status inquiry to the printer 200 (Step S21) and absence of response the response from the printer 200 (Step S25). However, those applications may be applied separately or used with part of them omitted.

The above embodiment shows an example where the status of the print server 100 is changed based on the status notification from the printer 200 (Step S42 in FIG. 3). However, the status may be changed in response to the inquiry from the print server 100. Furthermore, synchronization of the status may be omitted and the print job which has been transmitted to the printer 200 may be stored in the print server 100 in “held” status all the time.

Although various embodiments of the invention have been described, it should be noted that the invention is not limited to these embodiments and may include various configurations without departing from the spirit of the invention. For example, the control processes described above may be implemented by software or hardware.

What is claimed is:

1. A job management apparatus connected with a network separately from a printing device that manages status of a print job to be processed in the printing device connected with the network, comprising:
a retention module that stores the print job;
a transmitter that transmits the stored print job to the printing device; and
a delete inhibition module that inhibits the retention module from deleting the print job which has been transmitted out.

2. A job management apparatus in accordance with claim 1, further comprising:
a receiver that receives completion notification of the print job from the printing device,
wherein the delete inhibition module allows the retention module to delete the print job corresponding to the completion notification when receiving the completion notification.

3. A job management apparatus in accordance with claim 1, further comprising:
a receiver that receives notification regarding the status of the print job in the printing device,
wherein the retention module changes the status of the print job corresponding to the notification to the notified status when receiving the notification.

4. A job management apparatus in accordance with claim 1, further comprising:
an error detection module that detects error involved with printing in the printing device,
wherein the retention module changes the status of the print job corresponding to the detected error to halt that is out of print queue when the error is detected.

5. A job management apparatus in accordance with claim 4,
wherein the error detection module detects the error based on error notification from the printing device.

6. A job management apparatus in accordance with claim 4,
wherein the error detection module detects the error by inquiring to the printing device regarding at least either one of the status of the printing device or the status of the print job.

7. A job management apparatus in accordance with claim 4, comprising
a receiver that receives notification regarding performing status of the print job from the printing device,
wherein the error detection module determines that the error has occurred in the printing device when period up to the receipt of the notification is over predetermined period of time.

8. A printing device connected with a network separately from a job management apparatus that manages status of a print job, wherein the printing device performs the print job received from the job management apparatus, comprising:
a job management module that manages the print job by associating it with one of plural statuses that are preset; and
a notification module that informs the job management apparatus of the status every time the status of the print job is changed.

9. A method for managing status of a print job to be processed in a printing device connected with a network by means of a job management apparatus connected with the network separately from the printing device, comprising the steps of:
storing the print job in the job management apparatus;
transmitting the stored print job to the printing device; and
inhibiting deletion of the print job which has been transmitted out.

10. A method in accordance with claim 9, further comprising the steps of:
informing the job management apparatus of the status of the print job in the printing device from the printing device to the job management apparatus; and
changing the status of the corresponding print job among the print jobs stored in the job management apparatus to the notified status in response to the notification.

11. A recording medium in which a computer program is recorded in a computer readable manner, the computer program causes a job management apparatus connected with a network separately from a printing device to manage status of a print job to be processed in the printing device connected with the network, to attain the functions of:
storing the print jobs to be processed;
transmitting the stored print job to the printing device; and
inhibiting deletion of the print job which has been transmitted out.
